(19) United States
(12) Patent Application Publication
(10) Pub. No.: US 2009/0056208 A1
(43) Pub. Date: Mar. 5, 2009

(54) CUBING MACHINE FOR MANUFACTURE OF PLANT BIOMASS SOLID FUEL

(76) Inventors: Stephane Gauthier, La Broquerie (CA); Eugene Gala, Winnipeg (CA); Roger Balcean, La Broquerie (CA); Shaughn Broesky, La Broquerie (CA); Pierre Nadeau, La Broquerie (CA)

Correspondence Address: ADE & COMPANY INC., 2157 Henderson Highway, WINNIPEG, MB, R2G1P9, CA

(21) Appl. No.: 11/846,247

(22) Filed: Aug. 28, 2007

(51) Int. Cl. B30B 11/28

(52) U.S. Cl. 44/636

(57) ABSTRACT

A solid fuel is formed in a cuber to form body pieces formed of materials extruded through a die with a density greater than 35 lbs/cu ft; an energy content greater than 6500 BTU/lb; transverse dimensions less than 1.5 inches; and a length less than 4 inches; from plant biomass material which contains components when extended of greater than 1.0 inch. Primarily the materials are paper or other cellulose product and crop residue such as wheat straw. The cellulose and lignin from these materials act without additional binders as binders and encasing materials. The moisture content is maintained at a target value by mixing selected quantities of the materials without drying. The cubing machine has a feeding system where the space between the inner rotor and outer casing is smaller than 4 inches and the height of the outer flight is less than 1 inch.

The invention is related generally to the field of plant biomass solid fuel.

This application relates to and contains common subject matter with two co-pending applications filed on the same date by the same applicants under Attorney Docket Nos. 85776-102 and 85776-202.

### BACKGROUND OF THE INVENTION

Enormous quantities of agricultural residues or plant biomass materials are produced as by-products of agricultural and commercial processing. Some of these products include Flax Shives which are currently being used for bedding and for heating in large stoker boilers. Other agricultural crop residues found in large quantities include; Wheat Straw, Barley Straw, Corn Stover, Kentucky Bluegrass Screenings, Switch grass and Bagasse. All of these can be collected and cubed to produce solid fuel.

The other product involved in this invention is paper residues collected from recycling facilities. Due to the decrease in demand for recycled paper products, more of these products are being disposed of in local landfills. These paper products include OCC (old corrugated cardboard), mixed waste, boxboard and news print or any paper product that can shredded into a suitable size, Currently coal is widely used as a fuel for many residential and commercial combustion furnaces. Coal is widely available but is increasing in cost and also contains many contaminants which render it less than entirely suitable as a fuel. However it's characteristics of energy contained, density, and remnant ash content are well established and suitable for combustion. Many such furnaces are therefore designed and produced particularly for the use of coal.

It would be highly desirable to provide a fuel product utilizing waste material such as plant residue, paper products and other materials where the products are formed into a structure which simulates coal in regard to its characteristics so that the fuel can be used as a simple replacement for the existing coal fuel used in the existing furnaces.

There are many briquettes available for combustion in fireplaces and these are commonly produced from compressed wood products such as sawdust. However such briquettes are relatively expensive and do not provide the characteristics of coal as a fuel. Yet further the briquettes are expensive to produce since the materials from which they are produced must be dried and the briquettes tend to produce significant quantities of fines or dust when broken down. These characteristics reduce the desirability of such briquettes as a replacement for conventional coal in residential or commercial furnaces.

The technique for compression of materials to form a compressed or densified product known as “cubing” is well established and widely used. The design of the Cuber has been available for 40 years and has changed little in that time. Such a Cuber is available from Cooper Cubing Systems of Burley, Idaho USA. The Cuber of this type is robust and relatively inexpensive. Such Cubers have however been used for the compression of forage crops such as alfalfa. The alfalfa is introduced into the cubing system and the high compression up to 6,000 psi of the material as it enters the series of dies creates an effective product which is extruded through the dies. The Cuber is particularly designed and arranged to provide and effective cubing action of the alfalfa to maintain an attractive green appearance of the product so that it is attractive to the animals to be fed and to the handlers of those animals.

Some attention has been given to the possibility for using such Cubers for compressing other materials but little or no success has been achieved to date.

An example of a Cuber of this type is shown in a brochure of the above company and such Cubers include an exterior housing with a longitudinal axis where the housing is held stationary with the axis horizontal. A feed duct is provided at the top of the housing for feeding the material to be cubed into the interior of the housing. The housing defines a cylindrical inner surface at the feed section where a web of the material to be compressed enters through the feed opening.

At one end of the cylindrical feed section is provided a pair of clamping disks with the disks lying in parallel radial planes of the axis. One of the disks at the feed section has a central opening through which the material feeds to be located between the two disks.

The disks act to clamp an array of radially extending, axially located dies with the array surrounding the axis and located between the clamping disks. The clamping disks clamp the dies between them using bolts passing through holes in the dies to squeeze the disks together and hold the dies at a fixed position surround the axis. The dies thus define a radially inwardly facing inlet mouth with a duct of the die extending radially outwardly toward an outlet. Each die therefore forms an extrusion tube with the material being compressed into the inner end of the die.

Within the outer housing is provided an inner rotor with a generally cylindrical outer surface at the inner surface of the feed housing of the outer housing. The inner rotor also caries a press wheel lying in the radial plane of the dies so that the press wheel rolls in the radial plane on the dies at the inlet mouth with the press wheel being mounted such so that as an axis of rotation of the press wheel rotates around the axis of the outer housing. Thus as the press wheel rotates it squeezes the material outwardly into the mouth of the die to be compressed and extruded through the die. The outer housing carries on its inner surface a plurality of upstanding flights extending from the outer surface inwardly toward the axis. The outer surface of the inner rotor also carries one or more flights which rotate with the rotor so as to sweep the material from the feed opening to the inlet of the dies where the material is engaged by the press wheel.

Outside the mouth of the dies where the material exits there is provided an angled plate so that the material as it exits engages the plate and is diverted to one side of its normal direction of movement thus causing breakage of the extruded solid stream of the material into individual pieces giving the name “Cuber”, even though the length of the broken pieces may vary and differ from the transverse dimension so that the product produced is not literally a “cube”.

### SUMMARY OF THE INVENTION

It is one object of the present invention to provide a machine for manufacturing solid fuel formed from a plant biomass material.

According to a first aspect of the invention there is provided an apparatus for compressing plant biomass material to form a solid fuel material for combustion, the apparatus comprising:

an outer housing having a longitudinal axis;

the outer housing a generally cylindrical feed section coaxial relative to the axis and defining a generally cylindrical inner surface;

an outer housing having a feed opening at the feed generally cylindrical feed section for entry of a web of the plant biomass material generally radially inwardly into the outer housing;

a pair of clamping disks at one axial end of the feed section with the disks lying in parallel radial planes of the axis;

an array of radially extending, angularly located dies with the array surrounding the axis and located between the clamping disks so as to be clamped therebetween by axial compression of the dies;

each die having a radially inwardly facing inlet mouth and a radially outwardly facing outlet;

an inner rotor mounted within the outer housing for rotation around the axis;

the inner rotor having a generally cylindrical outer surface at the inner surface of the feed section of the outer housing so as to define an annular chamber therebetween into which the plant biomass material is fed;

the inner rotor carrying a press wheel lying in a radial plane at the dies for rolling in the radial plane on the dies at the inlet mouth with the press wheel being mounted such that an axis of rotation of the press wheel rotates around the axis of the outer housing;

the outer housing having on the inner surface a plurality of upstanding outer flights extending from the outer surface toward the axis;

each of the flights extending from a lead end at the feed opening around the inner surface to a trailing end at the dies;

the lead ends being spaced along the axis across the feed opening so as to receive separate parts of the web of the biomass material in separate paths defined between the flights;

the trailing ends being spaced angularly around the dies so as to feed the separate parts to the dies at the angularly spaced positions to maintain a generally constant feed around the dies;

the outer surface of the inner rotor having an upstanding inner flight extending generally diagonally across the feed opening such that the inner flight of the inner rotor sweeps across the feed opening as the inner rotor rotates so as to tend to direct the material from the feed opening into the separate paths between the flights on the outer housing;

the annular space between the inner surface and the outer surface being less than 4.0 inches in a radial direction.

Preferably the annular space is less than 3.0 inches.

Preferably the annular space is of the order of 2.5 inches.

Preferably the outer flights on the outer housing have a height from the outer surface which is greater than a height of the inner flight on the inner surface from the inner surface.

Preferably the ratio of the height of the outer flights to the height of the inner flights is greater than 1.3 to 1.0 and preferably greater than 1.5 to 1.0.

Preferably the dies are mounted on bolts extending axially between the clamping disks where the bolts are arranged to shear in the event that pressure on one or more of the dies in the radially outward direction from the press wheel exceeds a predetermined maximum thus causing the sheared dies to move outwardly and wherein there is provided a detection band surrounding the dies which is actuated in the event that one or more of the dies is forced outwardly.

Preferably the detection band includes at least one conductor which is ruptured in the event that one or more of the dies is forced outwardly.

Preferably the press wheel is arranged such that the pressure on the material in the die is greater than 6000 psi.

According to a second aspect of the invention there is provided an apparatus for compressing plant biomass material to form a solid fuel material for combustion, the apparatus comprising:

an outer housing having a longitudinal axis;

the outer housing a generally cylindrical feed section coaxial relative to the axis and defining a generally cylindrical inner surface;

an outer housing having a feed opening at the feed generally cylindrical feed section for entry of a web of the plant biomass material generally radially inwardly into the outer housing;

a pair of clamping disks at one axial end of the feed section with the disks lying in parallel radial planes of the axis;

an array of radially extending, angularly located dies with the array surrounding the axis and located between the clamping disks so as to be clamped therebetween by axial compression of the dies;

each die having a radially inwardly facing inlet mouth and a radially outwardly facing outlet;

an inner rotor mounted within the outer housing for rotation around the axis;

the inner rotor having a generally cylindrical outer surface at the inner surface of the feed section of the outer housing so as to define an annular chamber therebetween into which the plant biomass material is fed;

the inner rotor carrying a press wheel lying in a radial plane at the dies for rolling in the radial plane on the dies at the inlet mouth with the press wheel being mounted such that an axis of rotation of the axis of the press wheel rotates around the axis of the outer housing;

the outer housing having on the inner surface a plurality of upstanding outer flights extending from the outer surface toward the axis;

each of the flights extending from a lead end at the feed opening around the inner surface to a trailing end at the dies;

the lead ends being spaced along the axis across the feed opening so as to receive separate parts of the web of the biomass material in separate paths defined between the flights;

the trailing ends being spaced angularly around the dies so as to feed the separate parts to the dies at the angularly spaced positions to maintain a generally constant feed around the dies;

the outer surface of the inner rotor having an upstanding inner flight extending generally diagonally across the feed opening such that the inner flight of the inner rotor sweeps across the feed opening as the inner rotor rotates so as to tend to direct the material from the feed opening into the separate paths between the flights on the outer housing;

wherein the outer flights on the outer housing have a height from the outer surface which is greater than a height of the inner flight on the inner surface from the inner surface.

According to a third aspect of the invention there is provided an apparatus for compressing plant biomass material to form a solid fuel material for combustion, the apparatus comprising:

an outer housing having a longitudinal axis;

the outer housing a generally cylindrical feed section coaxial relative to the axis and defining a generally cylindrical inner surface;

an outer housing having a feed opening at the feed generally cylindrical feed section for entry of a web of the plant biomass material generally radially inwardly into the outer housing;

a pair of clamping disks at one axial end of the feed section with the disks lying in parallel radial planes of the axis;

an array of radially extending, angularly located dies with the array surrounding the axis and located between the clamping disks so as to be clamped therebetween by axial compression of the dies;

each die having a radially inwardly facing inlet mouth and a radially outwardly facing outlet;

an inner rotor mounted within the outer housing for rotation around the axis;

the inner rotor having a generally cylindrical outer surface at the inner surface of the feed section of the outer housing so as to define an annular chamber therebetween into which the plant biomass material is fed;

the inner rotor carrying a press wheel lying in a radial plane at the dies for rolling in the radial plane on the dies at the inlet mouth with the press wheel being mounted such that an axis of rotation of the axis of the press wheel rotates around the axis of the outer housing;

the outer housing having on the inner surface a plurality of upstanding outer flights extending from the outer surface toward the axis;

each of the flights extending from a lead end at the feed opening around the inner surface to a trailing end at the dies;

the lead ends being spaced along the axis across the feed opening so as to receive separate parts of the web of the biomass material in separate paths defined between the flights;

the trailing ends being spaced angularly around the dies so as to feed the separate parts to the dies at the angularly spaced positions to maintain a generally constant feed around the dies;

the outer surface of the inner rotor having an upstanding inner flight extending generally diagonally across the feed opening such that the inner flight of the inner rotor sweeps across the feed opening as the inner rotor rotates so as to tend to direct the material from the feed opening into the separate paths between the flights on the outer housing;

wherein the dies are mounted on bolts extending axially between the clamping disks where the bolts are arranged to shear in the event that pressure on one or more of the dies in the radially outward direction from the press wheel exceeds a predetermined maximum thus causing the sheared dies to move outwardly and wherein there is provided a detection band surrounding the dies which is actuated in the event that one or more of the dies is forced outwardly.

### GENERAL DESCRIPTION

The arrangement described herein provides a method of producing a solid fuel cube capable of being used in various heating systems. The fuel is comprised of both agricultural crop residues and paper products.

More specifically the invention involves cubing biomass material in a mixture that will enhance cube durability and energy content. In particular the invention concerns the use of agricultural crop residues and paper products blended accordingly to produce a high quality solid fuel.

Described herein is a method of biomass fuel production using a modified cubing system. The invention involves cubing biomass material from a mixture that forms a briquette having enhanced cube durability and energy content. In particular the invention concerns the use of agricultural crop residues and paper products blended accordingly to produce a high quality solid fuel,

Specifically, material is selected that has high levels of cellulose and lignin which will aid in binding the products together. As discussed below, in preferred embodiments, the briquettes have at least 10% and preferably approximately 15%-25% cellulose content and 0.5%-5% lignin. It is of note that starches found in some residues will also aid in binding and elevate the energy content. It is noted that corn residues for example corn stovers are a suitable source of starches.

As discussed below, agricultural crop residues and paper products are mixed as discussed below, densified in a cubing device and then cooled.

Examples of agricultural crop residues include but are by no means limited to flax shives, wheat straw, barley straw, corn stovers, Kentucky Bluegrass screenings, switch grass and bagasse.

Flax shives are the by-product that is left over from the mechanical extraction of the fiber component of the flax straw. Depending on the equipment used to decorticate the straw some fiber will be passed with the shives. Shives would include any materials from the plant discarded after fiber extraction.

Corn stovers or corn residue is the plant matter left over after combine harvesting. When the grain is harvested by means of a combine with a corn header the residues including the cob and the leaf matter would all be included in the term corn stovers.

Hemp herd is the by-product that is left over from the mechanical extraction of the fiber component of hemp. Depending on the equipment used to decorticate the hemp, some fiber will be passed with the herd. Hemp herd would include any materials from the plant discarded after fiber extraction.

Bagasse consists of any plant matter left over from the sugar extraction process of a sugar cane plant. This would also include all residues left over in the field after harvest.

The paper products may be paper residues collected from recycling facilities. Suitable paper products may include but are by no means limited to the following: OCC (old corrugated cardboard), mixed waste, boxboard and news print or any paper product that can shredded into a suitable size to be mixed with the agricultural crop residues, as discussed below.

As discussed herein, in a preferred embodiment, the raw materials are shredded so to be no larger than 3 inch, so that the metering and delivery systems to the cubing device will not plug during the process. It is noted that typically larger pieces are less desirable as these will affect the durability and density of the finished product. Specifically, the larger pieces will tend to break out of the briquettes or cubes, thereby generating a lot of fines. As used herein, 3 inch refers to the diameter in the case of paper products and length for straws or crop residues when the materials are expanded from their crushed condition in the finished extruded product.

In some embodiments, wood particles can be added to the mixture, as discussed below. As will be appreciated by one of skill in the art, the smaller the wood particles are, the better their binding characteristics become. In other words, the more the wood particles are blended into the mixture that forms the briquettes, the more durable and dense the finished briquette product becomes.

As will be appreciated by one of skill in the art, wood from any kind of wood product may be used, for example but by no means limited to Douglas Fur, Pine, Spruce and Poplar.

The wood increases overall energy content of the final product, decreases overall ash content and helps with binding and durability of the briquettes.

As discussed below in the examples, the agricultural crop residues, the paper products, lime and in some embodiments wood products are mixed together at a moisture content between 10 to 25%. If the moisture falls below 10%, addition of water is required. In some embodiments, the addition of water is done via small jets that are located in the metering bin. Preferably, fine water droplets are used as the goal is to achieve the fastest absorption rate as possible so the moisture will be consistent in the mixture. The limiting factor on the nozzle size is the purity of the water and system pressure. The moisture is arranged as explained hereinafter so as not to exceed 25%.

Following mixing, unit portions of the mixture are densified into a briquette, where the very high levels of compression generally greater than 600 psi will generate heat so that the dies can be heated to in excess of 250° F., which will cause some of the lignin components in the mixture to break down further and subsequently produce a very hard external shell and a durable product.

There is generally at least one second dwell time in the dies. Dwell time is the time that the materials enter the dies to the time where the materials exit. The dwell time is dependant on temperature. The longer the material under compression is exposed to an elevated temperature the more the materials will bind together. The material preferably dwells in the dies for at least 1 second in order for the binding agents to activate or a poor quality product may result.

The densified briquettes are then cooled to room temperature. In a preferred embodiment, the briquettes are passed to a cooler, The cooler has a large perforated floor which the freshly made briquettes travel on. As the briquettes travel on the floor by a large drag chain, large fans circulate air though them. It takes approximately 20 minutes to cool the cubes to ambient temperature. Fines are removed by the perforations in the floor and are carried out by the return of the drag chain and recycled.

It is of note that in these embodiments, the cubes are actively cooled to room temperature. If the cubes where piled and left to air dry, the slow cooling can deteriorate the cubes to the point where they fall apart into fines. The active cooling is therefore desirable to set the many binding agents within the mixture so that a high quality product is formed.

The target is to achieve an energy value above 6500 BTU/lb and preferably in the range about 6500 to about 8500 BTU/lb. The average BTU of the mixtures listed below is 7900 BTU per pound @ 7% moisture content.

As will be apparent to one of skill in the art, the agricultural crop residues, paper products and wood particles may be prepared for cubing by means known in the art, for example but by no means limited to tub grinders, hammer mills and the like. Preparation of products for use are as follows: agricultural crop residues need to be shredded into suitable size in order to be properly distributed in the mixture. The optimum size is 3 inches or less. Paper products need to be shredded into suitable size in order to be properly distributed in the mixture. The optimum size is 3 inches or less. Wood residues need to be processed into suitable size in order to be properly distributed in the mixture. The optimum particle size is 1 inch or less.

As discussed herein, all products and additives are mixed together as per specified mixtures by means of a mixing unit and/or a metering system or the like. The mixture is to be homogenous and between 10% to 25% moisture, as discussed above.

As discussed above, the mixture is then densified by means of a cuber with the operating temperature is to be 140 to 250 Fahrenheit to achieve proper bonding of these mixtures. Dwell time in die should be regulated to a minimum of 1 second as discussed above.

The following are typical examples of materials which can be used:

### EXAMPLE I

Flax Shives 90% to 50%

Shredded paper (particle size to be less than 3 inch) 10% to 50%

### EXAMPLE II

Flax Shives 90% to 50%

Shredded paper (particle size to be less than 3 inch) 10% to 50%

Shredded wood and/or sawdust 10% to 50%

### EXAMPLE III

Kentucky Bluegrass screenings 90% to 50%

Shredded paper (particle size to be less than 3 inch) 10% to 50%

Shredded wood and/or sawdust 10% to 50%

### EXAMPLE IV

Shredded wheat straw and/or barley straw 90% to 50%

Shredded paper (particle size to be less than 3 inch) 10% to 50%

Shredded wood and/or sawdust 10% to 50%

### EXAMPLE V

Shredded corn stover 90% to 50%

Shredded paper (particle size to be less than 3 inch) 10% to 50%

Shredded wood and/or sawdust 10% to 50%

### EXAMPLE VI

Shredded sugar cane (Bagasse) 90% to 50%

Shredded paper (particle size to be less than 3 inch) 10% to 50%

Shredded wood and/or sawdust 10% to 50%

In all cases the moisture content is to be within 10% to 25%

### BRIEF DESCRIPTION OF THE DRAWINGS

One embodiment of the invention will now be described in conjunction with the accompanying drawings in which:

FIG. 1 is an isometric view of a cubed solid fuel product according to the present invention.

FIG. 2 is a schematic isometric view of plant for manufacture of the fuel product of FIG. 1.

FIG. 3 is an exploded view of one cuber of the plant of FIG. 2.

FIG. 4 is an isometric view of the cuber of FIG. 3.

FIG. 5 is a longitudinal cross sectional view of the cuber of FIG. 3.

FIG. 6 is a longitudinal cross sectional view of the inner rotor and the outer housing at the feed section only of the cuber of FIG. 3.

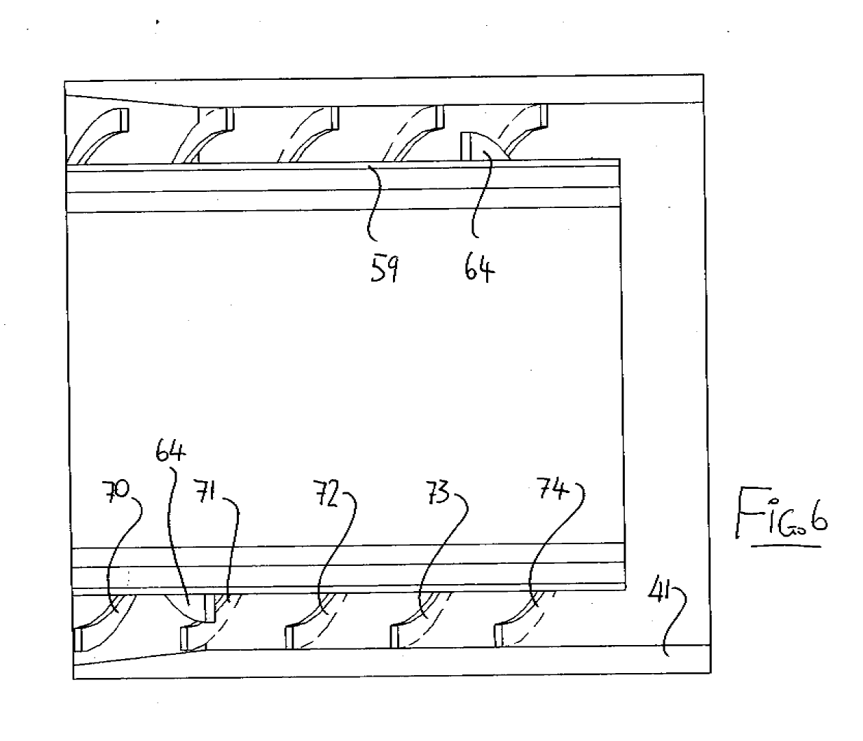

FIG. 7 is an isometric view of the inner rotor and the outer housing at the feed section only of the cuber of FIG. 3.

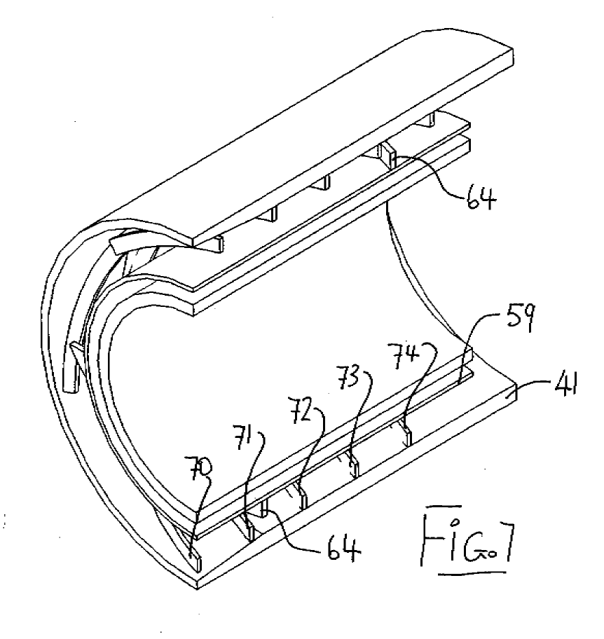

In the drawings like characters of reference indicate corresponding parts in the different figures.

### DETAILED DESCRIPTION OF THE EMBODIMENTS AS SHOWN

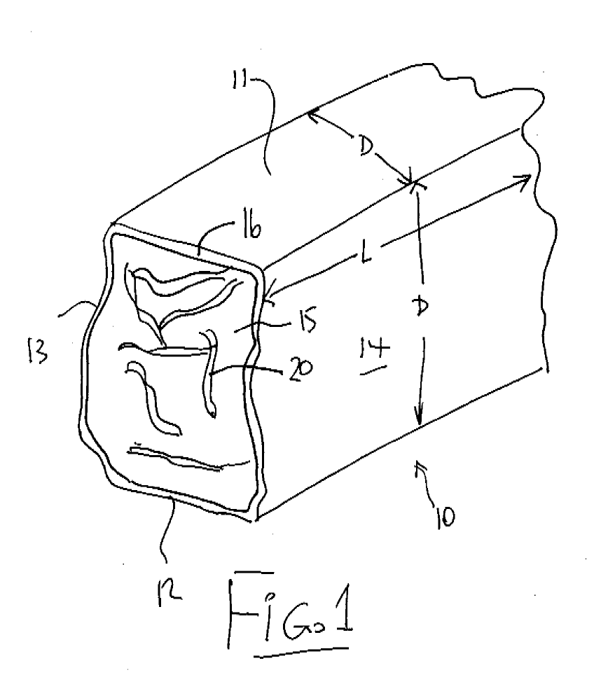

In FIG. 1 is shown one piece formed by the cubing system described herein after. This single piece is indicated at 10 and forms one of a multitude of such pieces which are extruded and then broken to length as described herein after.

Each piece 10 is extruded in square cross section to form top and bottom surfaces 11 and 12 and side surfaces 13 and 14. These surfaces are flat and are formed from the inside surface of the die as described herein after.

The piece so formed is formed from the plant biomass material previously described where the high temperatures generated in the compression process of the Cuber acts to cause the cellulose in the material to act as a binder within a central area 15 of the piece. Lignin within the material is driven to the exterior and is polymerized by the high temperature action to form a hard outer casing 16.

The high compression of the cubing system described herein after provides a densification of the materials to provide a density of the finished piece which is greater than 35 lbs/foot³ and preferably in the range from 35 to about 55 lbs/foot³. The die is selected so that the transverse dimensions of each side as indicated at D are less than 1.5 inch and more preferably less that 1.0 inch. The cubing system is arranged so that the length of the product as indicated at L between the two broken ends is preferably of the order of 1-2 inch and substantially all of the pieces have a length of less than 2 inch. This length can be selected as described herein after by adjusting the system so that the breakages occur after extrusion of a length of material to provide the length of the piece as required.

In some cases some of the pieces may have a length up to 4 inch. However in order to simulate the flow characteristics of coal, it is highly desirable that the length of the pieces is less than 4 inch and more preferably less than 2 inch.

The dimensions as described above allow the product to simulate the flow characteristics of coal both in passage through openings and also in transport of the material through augers and particularly the conventional or common 5 inch auger which is used in many furnace constructions.

As described herein after, the plant materials are selected such that they are shredded to a length of the pieces when extended which is greater than 1 inch. Thus the pieces when compressed may crumple into small elements or maybe laid into the structure as pieces as indicated at 20 where the pieces are laid through the structure and provide continuous connection through the structure. This selection of a shredding action which provides materials having a length greater that 1 inch and commonly greater than 2 inch or 4 inch reduces the amount of dust or fines within the structure so that the pieces when they break during the forming action or at any later time do not crumble to dust but instead break along fault lines generated by the elongate pieces such as the piece 20 first to break into larger chunks rather than mere dust or fines.

The selection of the materials as described herein provides a level of cellulose in the mixed materials which is sufficient to cause a binding action within the structure of the piece 10. Thus the level of cellulose is preferably greater than 10%. The cellulose acts as a binding agent during the heating of the material during the extrusion process.

In addition the selection of the materials is arranged to provide a level of lignin which is in the range 0.5 to 5% and is sufficient to generate a polymerized layer of the lignin on the outside surface forming a hard shiny shell of the casing as indicated at 16. This hard shiny shell of the lignin acts to conation the remaining materials on the interior to reduce again breakdown of the product and release of any fines or dust.

The materials as described herein are selected to provide under the amount of compression as described to provide the density as described a thermal energy in the range of about 6500 to about 8500 btu/lb. This again simulates the characteristics of coal which typically has an energy content in the range 7000-8000 btu/lb.

The compressed materials as described herein are selected to provide a quantity of ash after complete combustion of the product which is less than 10%, In addition the materials are selected so that the ash after complete combustion contains less than 20% of calcium, 20% of potassium and 75% of silica. Again this selection of the materials as described above provides such an ash content to again simulate the characteristics of coal so that the combustion does not provide excessive amounts of ash which would otherwise interfere with the use of existing coal fired furnace systems.

The shredding action as described above is carried out so that the amount of small components or comminuted components within the structures is maintained relatively low. Thus the proportion of components having a dimension of less than 0.5 inch is less than 40%.

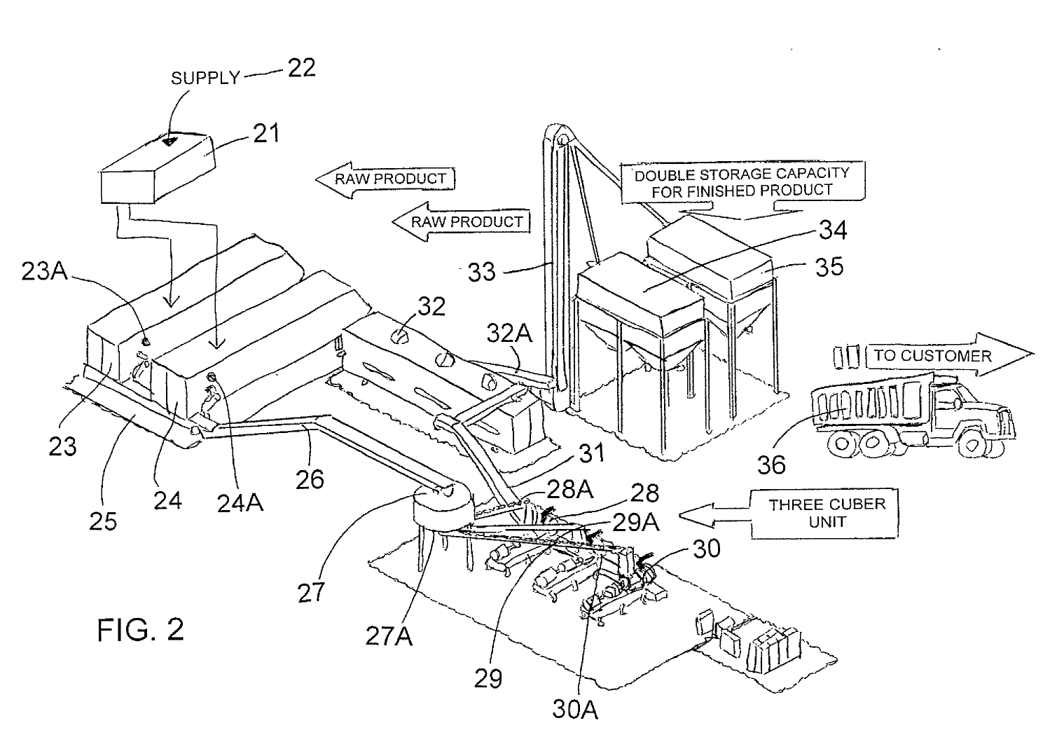

Turning now to FIG. 2 there is shown schematically a layout of a construction of a plant for manufacturing the fuel product of FIG. 1. The plant comprises a shredding system generally indicated at 21 into which the selected products for manufacturing the fuel are introduced from a supply 22. The shredder system as shown is adjustable so that it can be adjusted to the characteristics of the incoming materials. Alternatively separate shredders may be provided for different materials. When shredded the materials are supplied into a plurality of separate supply containers 23 and 24. These contain blending rollers and metering rollers so that the material supplied to these containers can be blended to a homogenous mixture and can be discharged through a metering system into a conveyer 25. The rate of supply from the containers 23 and 24 can be adjusted so as to provide predetermined quantities of the materials from those two containers into the conveyer 25. Thus the mixture may be modified to different ratios as determined by the adjustment of the system under control of a suitable computer control system (not shown). The conveyor 25 transfers to an elevating conveyor 26 which supplies to a metering system 27. The metering system 27 acts as a surge tank to maintain a continuous supply from a discharge at the base 27a of the metering system 27. Thus the conveyor 25 is operated periodically to maintain the surge tank 27 at a required fill condition between upper and lower limits.

The surge tank or metering unit 27 supplies three separate cubers 28, 29 and 30 as described in more detail herein after. Thus in the embodiment shown the metering system 27 separates the supplied mixture into three separate transferred ducts 28a, 29a and 30a supplying the three separate cubers with the material at the required predetermined rate.

The output from the cubers which is defined by the multitude of individual pieces of the type shown in FIG. 1 is deposited to a conveyor 31 which transfers the cubed material into a cooler 32. From the cooler the material is discharged into an elevator 33 and stored in product supply tanks 34 and 35 for discharge into transportation trucks 36 for transportation to a distribution network.

The cooler 32 is in effect an ambient air cooling system which deposits the materials from the conveyor 31 in a mat over a perforated floor of the cooler so that the air drawn through the material from the perforated floor by a fan acts to apply cooling air onto the product to reduce its temperature from an elevated temperature emerging from the extrusion dies to an ambient temperature. Thus the temperature as the material enters from the extrusion process can be of the order of 1702200 degrees F. and is cooled in the cooler down to a temperature of the order of ambient temperature of approximately 70 degrees.

This cooling action ensures that the binding material provided primarily by the cellulose is reduced in temperature to a set temperature thus maintaining the pieces in integral condition and reducing the possibility that the materials will break down to smaller pieces than the desired cubes of the above described dimensions.

The cooler carries the mat of the material along the length of the container forming the cooler using a large drag chain or conveyor arrangement which transports the pieces across the horizontal floor from an inlet end toward a discharge end. During this movement the materials are deposited onto the perforated floor so that any extra fines breaking away from the pieces can collect through the floor into a suitable collection system where they can be returned into the chambers 23 and 24 for repeated processing.

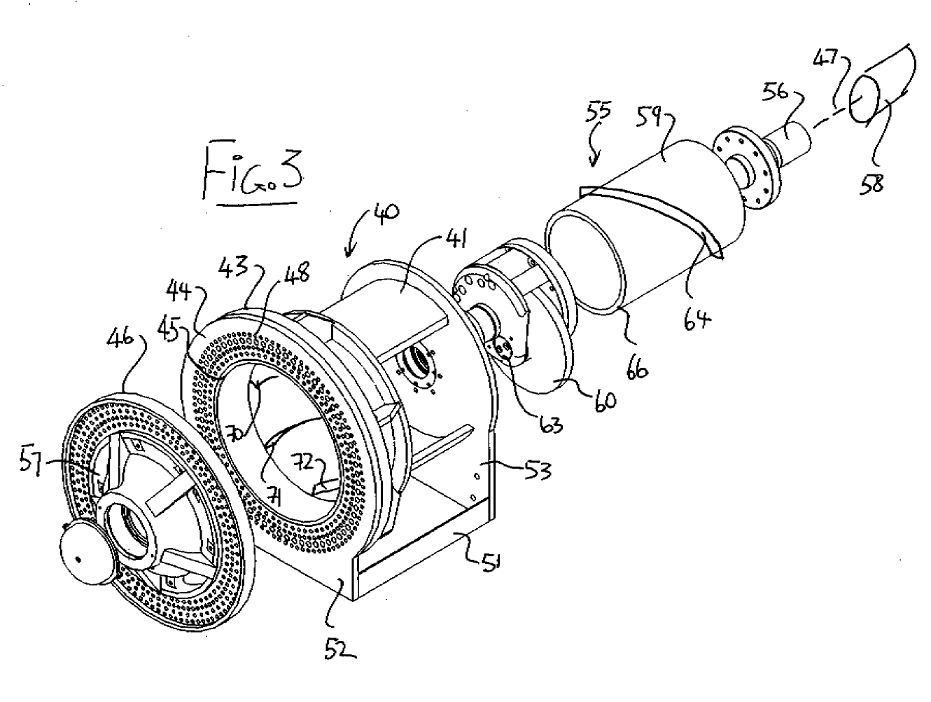

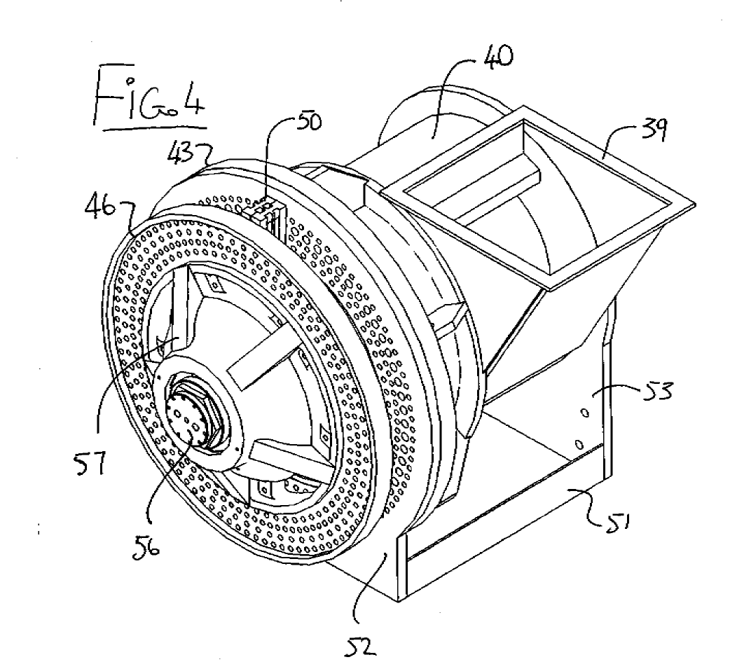

One of the cubing machines is shown is FIGS. 3, 4 and 5. This comprises an outer housing 40 in the form of a cylindrical drum 41 with an inlet duct 39 supplying the feed material from the conveyor into the interior of the drum. The drum has a cylindrical inside surface 42. At the end of the drum is provided a first clamping disk 43 which is welded to the end of the tube forming the drum and extends outwardly there from to form an annular disk shape as indicated at 44. The disk has a circular interior 45 matching the end of the drum 41. Thus material passing along the inside surface of the drum can pass through the hole 45 in the disk and enter the area on the outside face of the disk 43 and adjacent to the second end disk 46. The disks lay in common radial planes of an axis 47 of the drum. The disks are generally coextensive. The disks act as clamping disks and have a series of mounting holes 48 in co-operating patterns for receiving axially extending bolts between the disks. The disks thus can be used to clamp a series of dies 50 so that the dies are arranged angularly around the axis 47 with each die providing a duct through which the material from the interior of the drum can be extruded. The dies thus are arranged around the axis with an inside face of the die facing toward the interior and located just outside the inner edge 45 of the disk 43. Each die thus forms a tube extending radially outwardly from the inner end at the edge 45 to an outer end extended beyond the outer edge of the disk.

The inner rotor 55 mounted within the outer housing 40 comprises a shaft 56 extending along the axis 47. The shaft 47 is mounted in end bearings with one bearing be located in an end capped 57 of the disk 46 and the second bearing being located in the end plate 53. Thus the shaft is carried on the axis 47 and can rotate around the axis 47 driven by a motor 58.

The inner rotor 55 carries a feed drum 59 which is located axially aligned with the inside surface of the casing 41 so that the feed drum acts to carry the feed material along the inside surface of the casing 41 to the circular opening 45 in the disk 43 so that the material can be presented through that opening to the dies.

The inner rotor 55 further includes a press wheel 60 carried on a support 61. The press wheel 60 is mounted with a wheel axis 63 offset from the shaft 56 and the axis 47. Thus the axis of the press wheel can be rotated around the axis 47 so that the wheel rolls around the inside surfaces of the dies moving from each die to the next as the shaft rotates. Support 61 is suitably designed to carry the press wheel to apply onto the inside surfaces of the dies a significant force providing compression of the material within the dies up to a force preferably greater than 6000 psi and preferably up to a pressure of the order of 10000 psi.

The drum 59 has an outer surface 63 which is located at a position spaced from the inside surface 42 of the outer casing 41. This defines therefore an annular chamber between these two surfaces. On the outside surface of the drum 59 is provided a flight 64 which extends diagonally along the outside surface 63 so as to form a helix defining an auger which rotates around the axis 47 and thus acts to carry material axially along the outside surface 63 of the drum toward the end 66 of the drum at the press wheel 60. It will be appreciated that the end 66 is located at the opening 45 in the disk 43 so that the action of the flight 64 is to carry the material into the area between the two disks and through the opening 45 to feed into the compression zone defined between the inside surfaces of the dies and the press wheel.

On the inside surface 42 of the drum 41 is provided a series of flights 70, 71, 72, 73 and 74. These flights have a leading end on the interior surface 42 at the feed opening 39. Thus the leading ends are spaced axially along the inside surface equal-distantly so as to receive equal amounts of the mat of material which is fed through the opening 39. Each flight curves around the surface 42 so that the flight moves axially along the inside surface 42 and curves around the inside surface 42 so that the space between the flights for receiving the material gradually turns from its initial axial position around to form a space between the flights at the opening 45 in the disk 43. This space gradually increases in width since the distance axially at the feed opening is less that the circumference of the opening 45.

The flight 64 thus cooperates with the flights 70 through 74 to sweep the material from the feed opening in a smooth flow to be discharged axially through the opening 45 in the disk 43.

It is essential that the feed movement is smooth so that the material is released through the opening 45 as a smooth flow to enter the compression space. Any changes in the thickness of the material as it emerges leads to vibration in the system since the amount of material to be compressed varies around the dies. Such variation is unacceptable in the operation of the device and therefore a smooth flow of the material in a mat form at the feed opening through the system to the discharge into the compression zone is essential for the operation of the device.

The smooth flow of the materials described herein is obtained by providing a spacing between the outside surface 59 and the inside surface 42 which is less than 4 inch and is preferably less than 3 inch and more preferably of the order of 2.6 inch.

In addition the height of the flights 64 relative to the flights 70 through 74 is arranged so that the flights attach to the outer surface 42 which project inwardly toward the axis are greater in height than the flight 64. In practice with a spacing between the surfaces 42 and 63 of the order of 2.5 inch, the flight 64 has a height of the order of 1.0 inch and the flights 70 through 74 have a height of the order of 1.5 inch. Thus the ration of these heights is preferably greater than 1.3:1.0 and more preferably greater than 1.5:1.0.

This relatively small spacing between the surfaces 42 and 63 together with the change in ration of the heights of the flights has been found to provide an effective feeding action of the materials with which the present invention is concerned. The feeding action is maintained smooth so that a constant supply of the feed material enters the compression zone between the press wheel and the dies to ensure a constant feed of the material through the individual dies as a solid material extrusion.

The dies 50 are held in place in an annular array surrounding the compression zone with each die extending radially outwardly from the axis 47. In practice the dies are formed in two halves so that each die piece has on each side one half of the tubular opening forming the die. Thus when the pieces are clamped together the two halves of the duct forming the die are closed.

In the event that a foreign object enters the feed system and is not previously extracted by the feed preparation process, that foreign object may enter the compression zone and when located between a die piece and the press wheel may be of a nature that it cannot be compressed into the die opening. Such foreign objects can be stones or rocks, metal pieces or other solid objects. The preparation system can use conventional processes for extracting such materials such as magnets, gratings and the like. However it is generally impossible to extract all such materials and therefore the machine utilizes shear bolts for mounting the dies in place so that the presence of such a foreign object acts to expel one or more of the die pieces radially outwardly by shearing the mounting bolts for that or those die pieces.

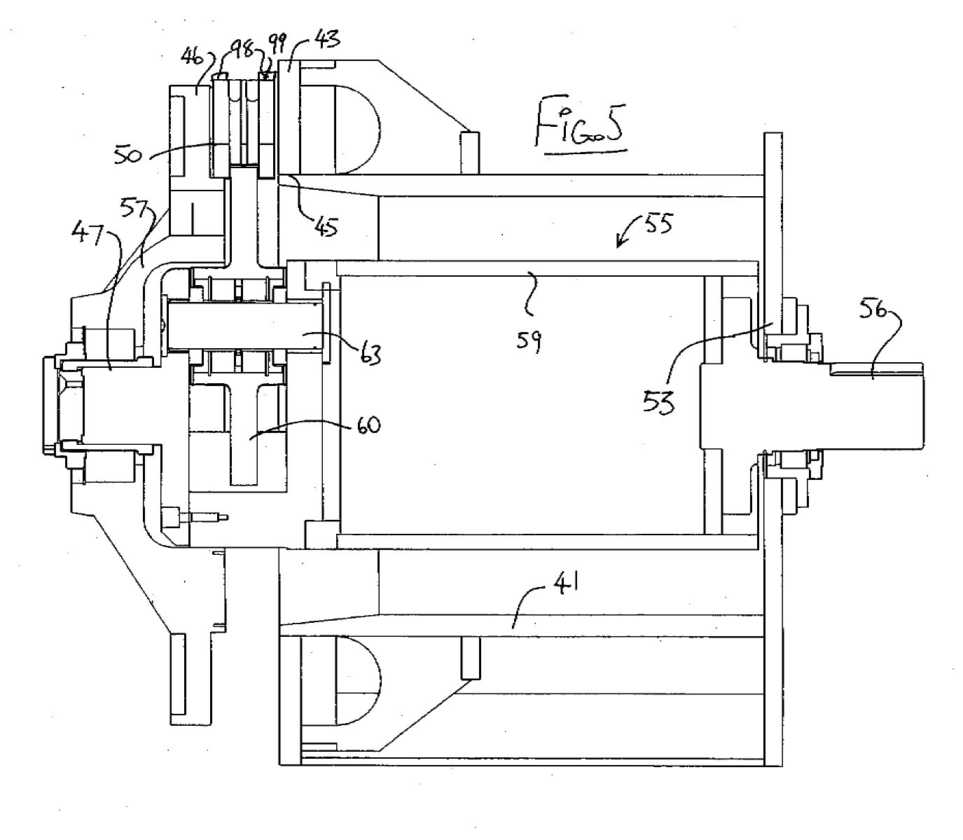

In order to obtain an immediate indication of the movement of a die piece radially outwardly due to the presence of a foreign object, a tape 98 (FIG. 5) is mounted around the die pieces on one side of the die openings at the outlet with the tape including one or more peripherally extending conductors 99. On outward radial movement of a die piece, therefore, the tape 98 is fractured thus breaking one or more conductors 99. This break in a conductive path can be sensed by detecting a change in voltage or a change in current flow and can be communicated to the central control system for the plant of FIG. 2. The central control system can therefore shut down immediately the rotation of the particular cubing machine where the detection has occurred to prevent further damage.

Turning now again to FIG. 2, the process of mixing the materials to provide the feed to the individual feeders is now described in more detail. In particular the feed materials are selected into one or other of the supply containers 23 or 24 depending primarily on the moisture content. Thus in the container 23 is provided materials which are generally of a drier nature such as recycled paper products. This material acts as a dry component for the mixture and allows a second container 24 to receive materials of differing levels of moisture content.

Target moisture content for the materials supplied to the cubers is of the order of 17%. However for operation to occur, the moisture content can lie in the range 10% to 25%.

The materials selected for the container 23 are preferably arranged to provide a moisture content of the order of 6% to 8%. This is typical from recycled paper products whether those products be newsprint from recycled newspapers or commercial products such as recycled cardboard materials. These materials are therefore shredded and entered into the supply container 23 to provide a supply of the low moisture materials for admixture into the total content at the conveyor 25.

Other refined cellulose materials may also be used instead of or as an addition to paper products conveniently used. Paper products are widely available at low cost as a recycled material. However as an alternative other materials can be used for example steam exploded straw can be used which is a significant source of refined cellulose material provided in a form which presents the cellulose in a manner which allows it to be utilized in the binding process as a binding material when activated by the heat and steam generated by the compression in the die as previously described.

Steam exploded straw is generated in a process by which a quantity of straw is heated in moisture to a temperature significantly greater than 100 degrees C. by applying pressure to the contents. Thus super heated steam enters the cellulose structure of the straw and on instantaneous release of the pressure the presence of the super heated steam within the cellular structure act to explode the cellular structure to form refined cellulose in a fluffy low moisture content condition. The process can be managed so that the material when release from the process has the required moisture content of 6-8% which is suitable for the low moisture materials within the container 23.

The steam exploded straw also releases the lignin content which can be extracted using solvents if required or can remain within the structure as part of the binding process to generate the outer shell as previously described.

The second container 24 is used to contain the variable feed material which can vary in moisture content since its origin may vary significantly. Even straw within a storage pile of cylindrically bales can have significantly different moisture content throughout the piled bales. Typically the materials to be supplied to the container 24 will have a moisture content significantly greater than the target moisture content of 17%. Moisture contents of up to 60% are possible.

The two materials supplied therefore to the containers 23 and 24 are shredded and supplied at the moisture content that they contain as they are received from whatever origin of the material arises. The moisture content is measured using probes 23a and 24a so that the moisture content of the material as it reaches the conveyer 25 is accurately determined. The control system then acts to blend the materials onto the conveyor 25 in proportions with the intention of providing a mixed material having a moisture content at the target value. As previously stated the target value is typically of the order of 17% but can lie within any value between 10% and 25% depending on process and conditions.

The moisture content of 17% is selected since it has been determined that the process tends to dry off during the cubing action approximately 10% moisture by converting that moisture into steam which is then released from the product after the cubing process. Thus an initial feed moisture content of 17% is reduced by the release of 10% moisture to a moisture content of the order of 7% in the finished product as they enter the cooling chamber 32.

The amounts of the materials from the dry container 23 and the wet container 24 can therefore vary widely depending on the moisture content. In addition to the moisture value it is necessary to insure that the finished material contains at least 10% cellulose and at 0.5 to 5% lignin. Thus the material cannot consist solely of the paper since this has little or no lignin content. Therefore is a minimum quantity of the straw or other crop residue material which is required in the mixture and this also must be taken into account in the moisture mixing process.

However, the mixing process is arranged to provide the target value of the order of 17% without the application of any heat. In the event that the target value cannot be maintained at the 17% level this can be allowed to increase up to 25% and the process still operates effectively.

In the event that the moisture content drops below 17%, additional moisture can be added at the surge tank 27 in the form of spray nozzles located in that tank. However this is only carried out when it is essential to do so. Thus the intention is that the materials be managed so that wherever possible the moisture content is maintained above the 10% value and preferably at the 17% value.simply by managing the mixing process In order to carry out this mixing action to the required levels of cellulose, lignin and moisture, additional containers may be provided so that the management of the system can utilize different straw products at different moisture contents within different supply containers. Another supply container might be used for wood products such as saw dust when available. In this way more flexibility of mixing is available to allow the control system to maintain better the accuracy of the moisture content while providing the minimum values and preferably significantly higher values of the cellulose and lignin content.

In the event that the moisture content exceeds the target value of 17% and reaches up to the maximum value of 25%, this moisture content can be processed through the system. However the moisture content of the products entering the chamber 32 are measured by a sensor 32a. The target value of the 6 moisture content of the finished product is 6-8% in the event that the moisture content of the feed material is 25% to be appreciated that the moisture content of the product at the sensor 32a will be of the order of 15%. In the event that such a moisture content above the target moisture content is detected, the cooling process in the chamber 32 is slowed in order to increase the dwell time of the materials within the cooler chamber 32. Thus the product is reduced in moisture content by being maintained within the cooling chamber 32 for a longer period of time to reduce or extract the moisture which is drawn from the product by the air flow. This drying action is effected without the application of additional heat and is carried out strictly by the ambient air flow which carries the heat and reduces the temperature to the ambient value of the order of 17%.

The whole process therefore is carried out by effectively managing the moisture by the mixing action and by the cooling action without the requirement for added heat at any point in the process. It would be appreciated of course that adding heat is a significant expense in the manufacture of the product so that the economics of the process may be cancelled if significant quantities of drying heat are required. It is appreciated in this regard that the product is competing with coal which requires as a cost input only the cost of extraction and transportation without any product cost and generally without any drying cost. It is essential therefore in the present process that the amount of heat required be maintained at a minimum so as to maintain the economics of manufacture of the product as close to that of the coal materials of which the present materials are in competition.

The supply materials are therefore typically wheat and/or barley straw which provide the available lignin together with the paper materials or other refined cellulose which provides the available cellulose and the low moisture content for mixture with the generally higher moisture content of the crop residue. In place of the wheat or barley straw, other crop residues can be used such as flax shives, corn stover. Other crop residues such as canola straw can also be used. The use of the lignin and the cellulose as the binding and encasing elements avoids the necessity for the addition of other binding materials of a nature which do not contribute to the combustion product and require additional costs.

While the preferred embodiments of the invention have been described above, it will be recognized and understood that various modifications may be made therein, and the appended claims are intended to cover all such modifications which may fall within the spirit and scope of the invention.

1. Apparatus for compressing plant biomass material to form a solid fuel material for combustion, the apparatus comprising:
an outer housing having a longitudinal axis;
the outer housing a generally cylindrical feed section coaxial relative to the axis and defining a generally cylindrical inner surface;
an outer housing having a feed opening at the feed generally cylindrical feed section for entry of a web of the plant biomass material generally radially inwardly into the outer housing;
a pair of clamping disks at one axial end of the feed section with the disks lying in parallel radial planes of the axis;
an array of radially extending, angularly located dies with the array surrounding the axis and located between the clamping disks so as to be clamped therebetween by axial compression of the dies;
each die having a radially inwardly facing inlet mouth and a radially outwardly facing outlet;
an inner rotor mounted within the outer housing for rotation around the axis;
the inner rotor having a generally cylindrical outer surface at the inner surface of the feed section of the outer housing so as to define an annular chamber therebetween into which the plant biomass material is fed;
the inner rotor carrying a press wheel lying in a radial plane at the dies for rolling in the radial plane on the dies at the inlet mouth with the press wheel being mounted such that an axis of rotation of the press wheel rotates around the axis of the outer housing;
the outer housing having on the inner surface a plurality of upstanding outer flights extending from the outer surface toward the axis;
each of the flights extending from a lead end at the feed opening around the inner surface to a trailing end at the dies;
the lead ends being spaced along the axis across the feed opening so as to receive separate parts of the web of the biomass material in separate paths defined between the flights;
the trailing ends being spaced angularly around the dies so as to feed the separate parts to the dies at the angularly spaced positions to maintain a generally constant feed around the dies;
the outer surface of the inner rotor having an upstanding inner flight extending generally diagonally across the feed opening such that the inner flight of the inner rotor sweeps across the feed opening as the inner rotor rotates so as to tend to direct the material from the feed opening into the separate paths between the flights on the outer housing;
the annular space between the inner surface and the outer surface being less than 4.0 inches in a radial direction.

2. The apparatus according to claim 1 wherein the annular space is less than 3.0 inches.

3. The apparatus according to claim 1 wherein the annular space is of the order of 2.5 inches.

4. The apparatus according to claim 1 wherein the outer flights on the outer housing have a height from the outer surface which is greater than a height of the inner flight on the inner surface from the inner surface.

5. The apparatus according to claim 1 wherein the ratio of the height of the outer flights to the height of the inner flights is greater than 1.3 to 1.0.

6. The apparatus according to claim 1 wherein the ratio of the height of the outer flights to the height of the inner flights is greater than 1.5 to 1.0.

7. The apparatus according to claim 1 wherein the dies are mounted on bolts extending axially between the clamping disks where the bolts are arranged to shear in the event that pressure on one or more of the dies in the radially outward direction from the press wheel exceeds a predetermined maximum thus causing the sheared dies to move outwardly and wherein there is provided a detection band surrounding the dies which is actuated in the event that one or more of the dies is forced outwardly.

8. The apparatus according to claim 7 wherein the detection band includes at least one conductor which is ruptured in the event that one or more of the dies is forced outwardly.

9. The apparatus according to claim 1 wherein the press wheel is arranged such that the pressure on the material in the die is greater than 6000 psi.

10. Apparatus for compressing plant biomass material to form a solid fuel material for combustion, the apparatus comprising:
an outer housing having a longitudinal axis;
the outer housing a generally cylindrical feed section coaxial relative to the axis and defining a generally cylindrical inner surface;
an outer housing having a feed opening at the feed generally cylindrical feed section for entry of a web of the plant biomass material generally radially inwardly into the outer housing;
a pair of clamping disks at one axial end of the feed section with the disks lying in parallel radial planes of the axis;
an array of radially extending, angularly located dies with the array surrounding the axis and located between the clamping disks so as to be clamped therebetween by axial compression of the dies;
each die having a radially inwardly facing inlet mouth and a radially outwardly facing outlet;
an inner rotor mounted within the outer housing for rotation around the axis;
the inner rotor having a generally cylindrical outer surface at the inner surface of the feed section of the outer housing so as to define an annular chamber therebetween into which the plant biomass material is fed;
the inner rotor carrying a press wheel lying in a radial plane at the dies for rolling in the radial plane on the dies at the inlet mouth with the press wheel being mounted such that an axis of rotation of the axis of the press wheel rotates around the axis of the outer housing;
the outer housing having on the inner surface a plurality of upstanding outer flights extending from the outer surface toward the axis;
each of the flights extending from a lead end at the feed opening around the inner surface to a trailing end at the dies;
the lead ends being spaced along the axis across the feed opening so as to receive separate parts of the web of the biomass material in separate paths defined between the flights;
the trailing ends being spaced angularly around the dies so as to feed the separate parts to the dies at the angularly spaced positions to maintain a generally constant feed around the dies;
the outer surface of the inner rotor having an upstanding inner flight extending generally diagonally across the feed opening such that the inner flight of the inner rotor sweeps across the feed opening as the inner rotor rotates so as to tend to direct the material from the feed opening into the separate paths between the flights on the outer housing;
wherein the outer flights on the outer housing have a height from the outer surface which is greater than a height of the inner flight on the inner surface from the inner surface.

11. The apparatus according to claim 10 wherein the ratio of the height of the outer flights to the height of the inner flights is greater than 1.3 to 1.0.

12. The apparatus according to claim 10 wherein the ratio of the height of the outer flights to the height of the inner flights is greater than 1.5 to 1.0.

13. The apparatus according to claim 10 wherein the dies are mounted on bolts extending axially between the clamping disks where the bolts are arranged to shear in the event that pressure on one or more of the dies in the radially outward direction from the press wheel exceeds a predetermined maximum thus causing the sheared dies to move outwardly and wherein there is provided a detection band surrounding the dies which is actuated in the event that one or more of the dies is forced outwardly.

14. The apparatus according to claim 13 wherein the detection band includes at least one conductor which is ruptured in the event that one or more of the dies is forced outwardly.

15. The apparatus according to claim 10 wherein the press wheel is arranged such that the pressure on the material in the die is greater than 6000 psi.

16. Apparatus for compressing plant biomass material to form a solid fuel material for combustion, the apparatus comprising:
an outer housing having a longitudinal axis;
the outer housing a generally cylindrical feed section coaxial relative to the axis and defining a generally cylindrical inner surface;
an outer housing having a feed opening at the feed generally cylindrical feed section for entry of a web of the plant biomass material generally radially inwardly into the outer housing;
a pair of clamping disks at one axial end of the feed section with the disks lying in parallel radial planes of the axis;
an array of radially extending, angularly located dies with the array surrounding the axis and located between the clamping disks so as to be clamped therebetween by axial compression of the dies;
each die having a radially inwardly facing inlet mouth and a radially outwardly facing outlet;
an inner rotor mounted within the outer housing for rotation around the axis;
the inner rotor having a generally cylindrical outer surface at the inner surface of the feed section of the outer housing so as to define an annular chamber therebetween into which the plant biomass material is fed;
the inner rotor carrying a press wheel lying in a radial plane at the dies for rolling in the radial plane on the dies at the inlet mouth with the press wheel being mounted such that an axis of rotation of the axis of the press wheel rotates around the axis of the outer housing;
the outer housing having on the inner surface a plurality of upstanding outer flights extending from the outer surface toward the axis;
each of the flights extending from a lead end at the feed opening around the inner surface to a trailing end at the dies;
the lead ends being spaced along the axis across the feed opening so as to receive separate parts of the web of the biomass material in separate paths defined between the flights;
the trailing ends being spaced angularly around the dies so as to feed the separate parts to the dies at the angularly spaced positions to maintain a generally constant feed around the dies;
the outer surface of the inner rotor having an upstanding inner flight extending generally diagonally across the feed opening such that the inner flight of the inner rotor sweeps across the feed opening as the inner rotor rotates so as to tend to direct the material from the feed opening into the separate paths between the flights on the outer housing,
wherein the dies are mounted on bolts extending axially between the clamping disks where the bolts are arranged to shear in the event that pressure on one or more of the dies in the radially outward direction from the press wheel exceeds a predetermined maximum thus causing the sheared dies to move outwardly and wherein there is provided a detection band surrounding the dies which is actuated in the event that one or more of the dies is forced outwardly.

17. The apparatus according to claim 16 wherein the detection band includes at least one conductor which is ruptured in the event that one or more of the dies is forced outwardly.

18. The apparatus according to claim 16 wherein the press wheel is arranged such that the pressure on the material in the die is greater than 6000 psi.
